(19) United States
(12) Patent Application Publication
(10) Pub. No.: US 2003/0099450 A1
(43) Pub. Date: May 29, 2003

(54) Profile for limited mode fiber

(76) Inventors: Huailiang Wei, Allen, TX (US); Kejian Wang, Allen, TX (US)

Correspondence Address: LASERCOMM, INC., INTELLECTUAL PROPERTY DEPT., 2600 TECHNOLOGY DRIVE SUITE 900, PLANO, TX, 75074, US

(21) Appl. No.: 10/298,548

(22) Filed: Nov. 19, 2002

Related U.S. Application Data
(60) Provisional application No. 60/333,496, filed on Nov. 28, 2001.

(51) Int. Cl. G02B 6/22; G02B 6/16

(52) U.S. Cl. 385/127; 385/123

(57) ABSTRACT

A limited mode dispersion compensating optical fiber comprising four core areas, with the first area exhibiting a peak refractive index designated nc₁, a second core area surrounding the first core area exhibiting a peak refractive index nc₂, a third core area surrounding the second core area exhibiting a peak refractive index nc₃, a fourth core area surrounding the third core area exhibiting a peak refractive index nc₄ and a cladding area surrounding the fourth core area. The fourth core area is designed to have a low enough refractive index so as not to support additional modes. The limited mode dispersion compensating optical fiber supports the LP₀₂ mode, and exhibits average dispersion more negative than −250 ps/nm/km.

### CROSS-REFERENCE TO RELATED APPLICATIONS

The present application claims the benefit of the filing date of co-pending U.S. provisional application, S/ No. 60/333,496 filed Nov. 28, 2001 entitled “IMPROVED PROFILE FOR FEW-MODE FIBER”.

### FIELD OF THE INVENTION

The invention relates generally to optical fibers used in optical communication systems and in particular to high order mode dispersion compensating optical fibers.

### BACKGROUND OF THE INVENTION

Optical fiber has become increasingly important in many applications involving the transmission of light. When light is transmitted through an optical fiber, the energy follows a number of paths that are called modes. A mode is a spatially invariant electric field distribution along the length of the fiber. The fundamental mode, also known as the LP₀₁ mode, is the mode in which light passes substantially along the fiber axis. Modes other than the LP₀₁ mode, are known as high order modes. Fibers that have been designed to support only one mode with minimal loss, the LP₀₁ mode, are known as single mode fibers. A multi-mode fiber is a fiber whose design supports multiple modes, and typically supports over 100 modes. A limited mode fiber is a fiber designed to support only a very limited number of modes. For the purpose of this patent, we will define a limited mode fiber as a fiber supporting no more than 20 modes at the operating wavelength band. Fibers may carry different numbers of modes at different wavelengths, however in telecommunications the typical wavelengths are near 1310 nm and 1550 nm, with the C-Band being defined as approximately 1525 nm-1565 nm, and the L-Band being defined as approximately 1565-1615 nm.

As light traverses the optical fiber, different groups of wavelengths travel at different speeds depending on their wavelength, which leads to chromatic dispersion. Chromatic dispersion is defined as the differential of the group velocity in relation to the wavelength in units of picosecond/nanometer (ps/nm). In optical fibers the dispersion experienced by each wavelength of light is a combination of the material dispersion, and the dispersion created by the actual profile of the waveguide, known as waveguide dispersion. Total dispersion is defined as the algebraic sum of waveguide dispersion and material dispersion. In this patent, dispersion refers to the total chromatic dispersion. The units of dispersion are in picoseconds/nanometer (ps/nm), and a waveguide fiber may be characterized by the amount of dispersion per unit length of 1 kilometer, in units of ps/nm/km.

The differential of the dispersion in relation to wavelength is known as the slope, or second order dispersion, and is expressed in units of picoseconds/nanometer² (ps/nm²). Optical fibers may be further characterized by their slope per unit length of 1 kilometer, which is expressed in units of ps/nm²/km. For the purposes of this patent, the local slope at a particular wavelength is calculated by taking the difference between the dispersion at 5 nm above and 5 nm below the particular wavelength divided by 10 nm.

Transmission fibers typically exhibit a nearly linear dispersion curve, and thus exhibit nearly uniform positive local slope over the operative waveband. Local third order dispersion defined as the derivative of the local slope with respect to wavelength is thus very small over the entire operative waveband. For the purposes of this patent, local third order dispersion at a particular wavelength is calculated by taking the difference between the local slope at 5 nm above and 5 nm below the particular wavelength divided by 10 nm. Any mismatch between the combination of dispersion and local slope exhibited by the transmission media and the dispersion-compensating device will result in residual dispersion. Furthermore, any deviation from a linear dispersion curve by the dispersion-compensating device, will also contribute to residual dispersion.

Single mode fibers (SMF) designed as dispersion compensating fibers (DCF) are well known in the art, and typically exhibit dispersion on the order of −80 ps/nm/km. Unfortunately, single mode DCF exhibits a small effective area (A_{eff}) which limits the amount of power which may traverse the fiber without experiencing non-linear effects. New fibers that operate in the fundamental mode and compensate for both dispersion and slope have been recently marketed, however these suffer from an even smaller A_{eff}. Overall, DCF's are designed to introduce negative dispersion with zero or negative dispersion slope, in order to achieve broad dispersion compensation of the associated transmission fiber.

Few mode fibers designed to have specific characteristics in a mode other than the fundamental mode are also known as high order mode (HOM) fibers. The operative high order mode is also known as the desired mode. HOM fibers are particularly useful for compensating chromatic dispersion due to the large amount of negative dispersion that can be experienced by a signal traversing certain fibers in a high order mode. Additionally, HOM fibers may exhibit negative slope, opposite to the positive slope of most transmission fibers. Furthermore HOM fibers, in particularly those operating in the LP₀₂ mode, exhibit a larger effective area than corresponding DCFs based on the fundamental mode due to the larger mode field diameter of the LP₀₂ mode. A large effective area is indicative of low non-linear effects in the face of higher power transmission.

In HOM fibers the light in each mode travels at its own velocity, thus light traveling in different modes may interfere with each other at the detector. This is known as multi-path interference or MPI. Very efficient mode transformers, such as a transverse mode transformer of the type described in U.S. Pat. No. 6,404,951 are advantageously utilized to launch light almost exclusively in the desired mode, thus minimizing the amount of light traveling in modes other than the desired mode. However, coupling of the light from the desired mode to other modes while traversing the length of fiber remains a source of MPI, as is the recoupling of light that has left the desired mode back to the desired mode. One factor that influences the amount of mode coupling is the height of first doped area, known as Δ₁, with a greater Δ₁ leading to more mode coupling.

HOM fibers are often very sensitive to bending radius, with large losses in the high order mode being experienced even with relatively large radius bends. In order to make a practical dispersion compensating device the fiber typically must be coiled so as to be contained in a reasonably small location, however any increase in loss due to bending will increase the overall losses of the dispersion compensating device.

Fiber profiles designed to allow propagation of specific high order modes while functioning primarily in the fundamental mode exist. U.S. Pat. No. 5,448,674 discloses a limited mode fiber with a refractive index profile selected such that the fiber supports the LP₀₁ and LP₀₂ modes but does not support the LP₁₁ mode. Light propagating in the LP₀₁ mode experiences dispersion with a maximum of approximately −300 ps/nm/km at 1560 nm, with negative slope.

U.S. Pat. No. 5,802,234 discloses an HOM fiber in which light propagating in the LP₀₂ mode experiences dispersion, comprising a core, an inner cladding region contactingly surrounding the core, a refractive index ring and an outer cladding region that surrounds the index ring. The refractive index of the outer cladding region could be that of undoped silica or could be less than undoped silica. Light propagating in the LP₀₂ mode exhibits negative dispersion, and exhibits a minimum dispersion point in the operative waveband, thus the local slope of the HOM fiber changes sign in the operative waveband. Such an HOM fiber is not ideally suitable to compensate for the slope of a transmission fiber, which exhibits substantially uniform positive slope over the operative waveband.

U.S. Pat. No. 6,442,320 assigned to the current assignee of this application describes an HOM fiber exhibiting negative dispersion, negative dispersion slope and negative or zero third order dispersion for light propagating in the LP₀₂ mode substantially over the operative wavelength range. The HOM fiber profile comprises a center core portion, and an outer core portion surrounding the center core portion, a first cladding portion and a second cladding portion. Disadvantageously, a fiber designed and operated in an operative wavelength range with these characteristics has less than the maximum dispersion that can be achieved in the high order mode. Thus a longer length of HOM fiber is required, with a resultant higher loss, and greater MPI.

U.S. Pat. No. 6,453,102 discloses a number of profiles having a plurality of core segments exhibiting dispersion for light propagating in the LP₀₂ mode at 1550 nm. The profiles shown exhibit a core portion, and two further regions surrounding the core portion. A number of profiles exhibit dispersion whose absolute value does not exceed 200 ps/nm/km at 1550 nm, and thus are not suitable for compensating a typical transmission link without experience high loss and greater MPI than is desirable. Two profiles exhibit dispersion whose absolute value is greater than 200 ps/nm/km, thus being suitable for use to compensate a transmission link. Local third order dispersion of these profiles is negative for a significant portion of the operating waveband, and in addition the absolute value of the local third order dispersion is relatively large, with values exceeding 0.15 ps/nm³/km. As discussed above, operating an HOM fiber in a region of the waveband which exhibits negative local third order dispersion is non-optimal, because the dispersion experienced is less than the maximum dispersion which can be achieved in the high order mode. Thus a longer length of HOM fiber is required, with a resultant higher loss, and greater MPI. Furthermore, operating an HOM fiber in a region of the waveband that exhibits large values of local third order dispersion leads to a large residual dispersion component when used to compensate a typical transmission link.

U.S. Pat. No. 6,339,665 assigned to current assignee of this application describes a dispersion compensation device using at least two dispersion compensation fibers to compensate for dispersion present in an optical communication system. In at least one of the fibers the signal propagates substantially in a high order spatial mode. Typical HOM compensating fibers exhibits both high negative dispersion and high negative slope, and the second fiber thus acts as a trim fiber to fine-tune the dispersion and slope compensation.

There is therefore a need for an HOM fiber exhibiting maximal negative dispersion. Furthermore, any such fiber should preferably exhibit low bending loss.

### Definitions

n(r) is the refractive index profile as a function of radius along a waveguide fiber.

N_{eff} is defined as the effective refractive index of the mode.

Δ is defined in the conventional matter, namely Δ(r)=(n(r)−n₀)/n₀, where no is the refractive index of pure vitreous SiO₂ at the operative wavelength of 1550 nm, which is approximately 1.444.

The radii of the regions of the core are defined in terms of the index of refraction. A particular region begins at the point where the refractive index characteristic of that region begins, and a particular region ends at the last point where the refractive index is characteristic of that particular region. In general, we will use the point of return to the refractive index of the cladding to define the border between two adjacent regions that cross the cladding index. Radius will have this definition unless otherwise noted in the text.

Projected zero dispersion (PZD) is defined as

$${λ}_{0} - \frac{D ( {λ}_{0} )}{Slope ( {λ}_{0} )} .$$

Typically λ₀ is chosen as 1550 nm for the C band, while 1590 is chosen for the L band, and the local slope of the dispersion characteristic at that wavelength is used. A dispersion compensating fiber should ideally have the same PZD as the transmission fiber that it compensates. For a fiber exhibiting non-linear dispersion over the operative range, a best-fit line of the dispersion characteristic may be chosen for calculating dispersion, slope and PZD, which minimizes the absolute value of the maximum deviation between the actual dispersion curve and the best-fit line. Such a slope may differ from the local slope at a given wavelength.

Residual dispersion is defined as the sum of the actual dispersion exhibited by the transmission media and the compensating media, including any trim fiber, at each wavelength.

### SUMMARY OF THE INVENTION

Accordingly, it is a principal object of the present invention to overcome the disadvantages of prior art. This is provided in the present invention by a limited mode dispersion compensating optical fiber supporting at least one high order spatial mode comprising: a first core area having a refractive index designated nc₁, a second core area contactingly surrounding the first core area having a peak refractive index designated nc₂, a third core area contactingly surrounding the second core area having a peak refractive index designated nc₃, a fourth core area contactingly surrounding the third core area having a peak refractive index designated nc₄ and a cladding area surrounding said third core area having a refractive index designated n_{clad}, wherein the peak refractive index nc₁ is greater than nc₂, nc₃, nc₄ and nc_{clad}, the peak refractive index nc₃ is greater than nc₄ and nc_{clad}, and the peak refractive index nc₄ is between nc_{clad} and nc_{clad} plus 0.002, and wherein the optical fiber exhibits average dispersion more negative than −250 ps/nm/km in the high order spatial mode over an operative wavelength range.

In one preferred embodiment the optical fiber further exhibits negative local slope over the operative wavelength range. In one further preferred embodiment the local slope is more negative than −3 ps/nm²/km over the operative wavelength range, and in another further preferred embodiment the optical fiber further exhibits local third order dispersion whose absolute value is less than 0.15 ps/nm²/km over the operative wavelength range.

In another preferred embodiment the limited mode dispersion compensating fiber has a peak refractive index nc₂ less than nc_{clad}. In a further preferred embodiment the optical fiber exhibits negative local slope over the operative wavelength range, and still further preferably the optical fiber exhibits local slope more negative than −3 ps/nm²/km over the operative wavelength range. In another further preferred embodiment the optical fiber further exhibits local third order dispersion whose absolute value is less than 0.15 ps/nm³/km over the operative wavelength range, and still further preferably the optical fiber further exhibits local third order dispersion whose absolute value is less than 0.15 ps/nm³/km over the operative wavelength range. In yet another further preferred embodiment the average dispersion is more negative than −400 ps/nm/km over the operative wavelength range.

In another preferred embodiment the optical fiber exhibits local third order dispersion whose absolute value is less than 0.15 ps/nm³/km over the operative wavelength range, and in another preferred embodiment the high order spatial mode is the LP₀₂ mode. In another preferred embodiment the operative wavelength range comprises at least a portion of the wavelengths between 1525 nm and 1565 nm, and in another preferred embodiment the operative wavelength range comprises at least a portion of the wavelengths between 1565 nm and 1615 nm. In yet another preferred embodiment average dispersion is more negative than −400 ps/nm/km over the operative wavelength range.

The invention also provides for an optical communication system comprising an optical transmission fiber exhibiting positive dispersion and positive dispersion slope, a limited mode dispersion compensating optical fiber in optical serial communication with the optical transmission fiber, the limited mode dispersion compensating optical waveguide supporting the LP₀₂ mode, and a mode transformer in optical communication with the limited mode dispersion compensating optical fiber; wherein the limited mode dispersion compensating optical fiber comprises a first core area having a refractive index designated nc₁, a second core area contactingly surrounding the first core area having a peak refractive index designated nc₂, a third core area contactingly surrounding the second core area having a peak refractive index designated nc₃, a fourth core area contactingly surrounding the third core area having a peak refractive index designated nc₄ and a cladding area surrounding the third core area having a refractive index designated n_{clad}; wherein the peak refractive index nc₁ is greater than nc₂, nc₃, nc₄ and nc_{clad}, the peak refractive index nc₃ is greater than nc₄ and nc_{clad}, the peak refractive index nc₄ is greater than said nc_{clad} and wherein the optical fiber exhibits average dispersion more negative than −250 ps/nm/km in the high order spatial mode over an operative wavelength range.

In one preferred embodiment the limited mode dispersion compensating fiber exhibits negative local slope over the operative wavelength range. In another preferred embodiment the limited mode dispersion compensating fiber exhibits local slope more negative than −3.0 ps/nm²/km over the operative wavelength range, and further preferably the limited mode dispersion compensating fiber exhibits local third order dispersion whose absolute value is less than 0.15 ps/nm³/km over the operative wavelength range.

In another preferred embodiment the limited mode dispersion compensating fiber exhibits local third order dispersion whose absolute value is less than 0.15 ps/nm³/km over the operative wavelength range.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 depicts a high level block diagram of a prior art system comprising a dispersion management module;

FIG. 2 depicts a refractive index profile according to a first embodiment of the invention and a comparison profile;

FIG. 3 depicts the dispersion exhibited by the refractive index profile of FIG. 2 and the comparison profile;

FIG. 4 depicts the local slope exhibited by the refractive index profile of FIG. 2 and the comparison profile;

FIG. 5 depicts the local third order dispersion exhibited by the refractive index profile of FIG. 2 and the comparison profile;

FIG. 6 depicts the bending loss exhibited by the refractive index profile of FIG. 2 and the comparison profile;

FIG. 7 depicts a refractive index profile according to a second embodiment of the invention and a comparison profile;

FIG. 8 depicts the dispersion exhibited by the refractive index profile of FIG. 7 and the comparison profile;

FIG. 9 depicts the local slope exhibited by the refractive index profile of FIG. 7 and the comparison profile;

FIG. 10 depicts the local third order dispersion exhibited by the refractive index profile of FIG. 7 and the comparison profile;

FIG. 11 depicts the bending loss exhibited by the refractive index profile of FIG. 7 and the comparison profile;

FIG. 12 depicts a refractive index profile according to a third embodiment of the invention and a comparison profile;

FIG. 13 depicts the dispersion exhibited by the refractive index profile of FIG. 12 and the comparison profile;

FIG. 14 depicts the local slope exhibited by the refractive index profile of FIG. 12 and the comparison profile;

FIG. 15 depicts the local third order dispersion exhibited by the refractive index profile of FIG. 12 and the comparison profile; and

FIG. 16 depicts the bending loss exhibited by the refractive index profile of FIG. 12 and the comparison profile.

### DETAILED DESCRIPTION

The present embodiments enable a high order mode dispersion compensating fiber comprises a first core area surrounded by three additional core areas and a cladding. The fourth core area is designed to increase the negative dispersion while not adding additional modes to the limited mode fiber at the operative wavelength.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

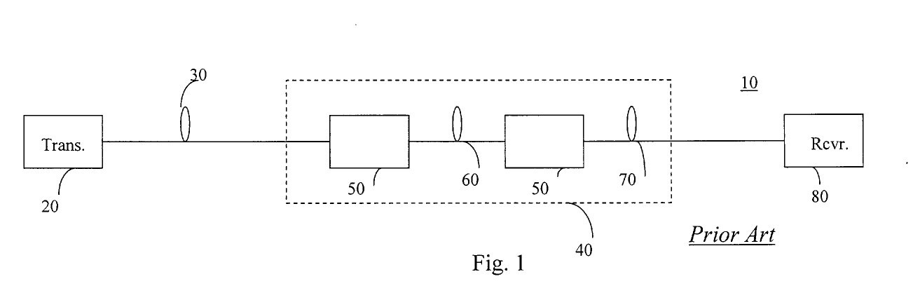

FIG. 1 illustrates a block diagram of a prior art transmission system 10 in accordance with the teaching of U.S. Pat. No. 6,339,665 whose contents are incorporated herewith by reference, comprising transmitter 20, single mode transmission fiber 30, receiver 80 and dispersion management device 40 comprising mode transformers 50, HOM fiber 60 and trim fiber 70. The output of transmitter 20 is connected to a first end of single mode transmission fiber 30, and the second end of transmission fiber 30 is connected to the input of dispersion management device 40. The input of dispersion management device 40 comprises first mode transformer 50, and the second end of transmission fiber 120 is thus optically connected to the input of first mode transformer 50. The output of first mode transformer 50 is connected to one end of HOM fiber 60, and the other end of HOM fiber 60 is connected to the input of second mode transformer 50. The output of second mode transformer 50 is connected to a first end of optional trim fiber 70 and the second end of trim fiber 70 is connected at the output of dispersion management device 40 to the input of receiver 80.

In operation system 10 of FIG. 1 utilizes the dispersion and slope of HOM fiber 60 and trim fiber 70 to compensate for dispersion and slope incurred in transmission fiber 30. Transmitter 20 transmits the optical signal into a length of transmission fiber 30, which in an exemplary embodiment comprises conventional single mode fiber exhibiting dispersion at 1550 nm of 17 ps/nm/km, with a slope of 0.057 ps/nm²/km. In an exemplary embodiment the length of transmission fiber 30 is 80 kilometers prior to the signal requiring amplification or reconversion to an electrical signal, and the signal experiences 1,360 ps/nm of total dispersion and a slope of 4.56 ps/nm² at 1550 nm. In another embodiment (not shown) receiver 80 is replaced with an optical amplifier. In still another embodiment (not shown), the first stage of an optical amplifier is inserted between the second end of transmission fiber 30 and the input of dispersion management device 40.

The output of transmission fiber 30, optionally having been amplified, is optically coupled to first mode transformer 50, which is designed to convert the optical signal from the fundamental mode to the single high order mode supported by HOM fiber 60, which in an exemplary embodiment is the LP₀₂ mode. Mode transformers 50 in an exemplary embodiment are of the type described in U.S. Pat. No. 6,404,951 entitled “Transverse Spatial Mode Transformer for Optical Communication” whose contents are incorporated herein by reference. In another embodiment a longitudinal mode transformer is utilized. It is to be noted that first mode transformer 50 is the input stage of dispersion management device 40, which in a preferred embodiment is designed to fully compensate for both the dispersion and slope of transmission fiber 30.

The output of first mode transformer 50 is optically coupled to a one end of a length of HOM fiber 60, which acts to partially compensate for the dispersion and slope imparted by transmission fiber 30. The second end of HOM fiber 60 is connected to input of second mode transformer 50 that transforms the signal from the operative high order mode to the fundamental mode, and outputs the signal to one end of trim fiber 70. Trim fiber 70 comprises a length of fiber with dispersion and slope characteristics designed to complete the compensation, if required. The second end of trim fiber 70 is connected through the output of dispersion management device 40 to receiver 80. In another embodiment complete dispersion and/or slope compensation is not required, and the device is designed to compensate for a specified fraction of the dispersion and/or slope of the transmission fiber.

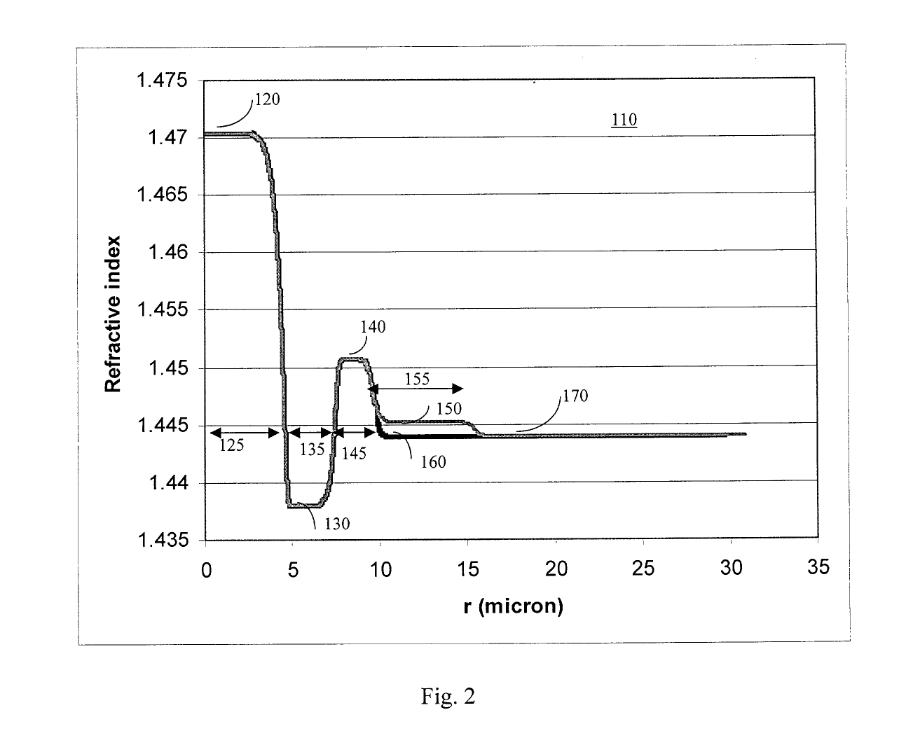

FIG. 2 illustrates a profile 110 of a few mode fiber designed to have negative dispersion, negative slope and improved bending loss in the “C” band of 1525 nm-1565 nm in accordance with a first embodiment of the subject invention. It is to be understood that the operative waveband may be less than or greater than 40 nm wide, and may not be centered on 1545 nm, although without exceeding the scope of the invention. The x-axis represents fiber radius and the y-axis represents the refractive index at a wavelength of 1550 nm. Fiber profile 110 comprises first core area 120 exhibiting radius 125, adjacent second core area 130 exhibiting width 135, adjacent third core area 140 exhibiting width 145, adjacent fourth core area 150 exhibiting width 155 and adjacent cladding area 170. Cladding area 160 adjacent to third core area 140 is shown for comparison. First core area 120 has a general shape wherein the refractive index varies over the radius 125 with a peak refractive index of 1.4705 corresponding to Δ₁ of 1.84%, and a radius of approximately 4.5 microns. Second core area 130 has a general shape exhibiting a depressed index of approximately 1.4380 corresponding to Δ₂ of −0.42%, with a width 135 of approximately 2.53 microns. Third core area 140 exhibits a general shape with an increased refractive index of approximately 1.4505 corresponding to Δ₃ of 0.45%, which is significantly lower than first core area 120. Third core area 140 covers a width of approximately 3.04 microns. Fourth core area 150, which increases negative dispersion, reduce bending sensitivity, increase negative slope and increase the cutoff wavelength exhibits an increased refractive index of approximately 1.4452 corresponding to Δ₄ of 0.083%, which while significantly lower than third core area 140, is still increased in relation to cladding area 170. Fourth core area 150 covers a width of approximately 5.42 microns. Cladding area 170 extends the balance of the radius of the fiber as is known to those skilled in the art. Total fiber radius is approximately 125 microns, however other fiber radii may be utilized without exceeding the scope of the invention.

In comparison, cladding area 160 is shown, which indicates the fiber profile without the fourth cladding area 150. Thus without fourth cladding area 150, the refractive index declines to 1.444 at the end of third core area 140, and continues through cladding area 170 at the undoped refractive index of silica glass. Fourth area 150 is designed to improve the dispersion characteristics of profile 110 in the LP₀₂ mode, while not supporting any additional modes that would not have been supported in the profile without the additional fourth area. In a preferred embodiment, fourth core area 150 has a peak refractive index less than 1.446 corresponding to a maximum Δ₄ of 0.14%. In order to be effective, in a preferred embodiment fourth core area 150 covers a minimum width of at least 2 microns.

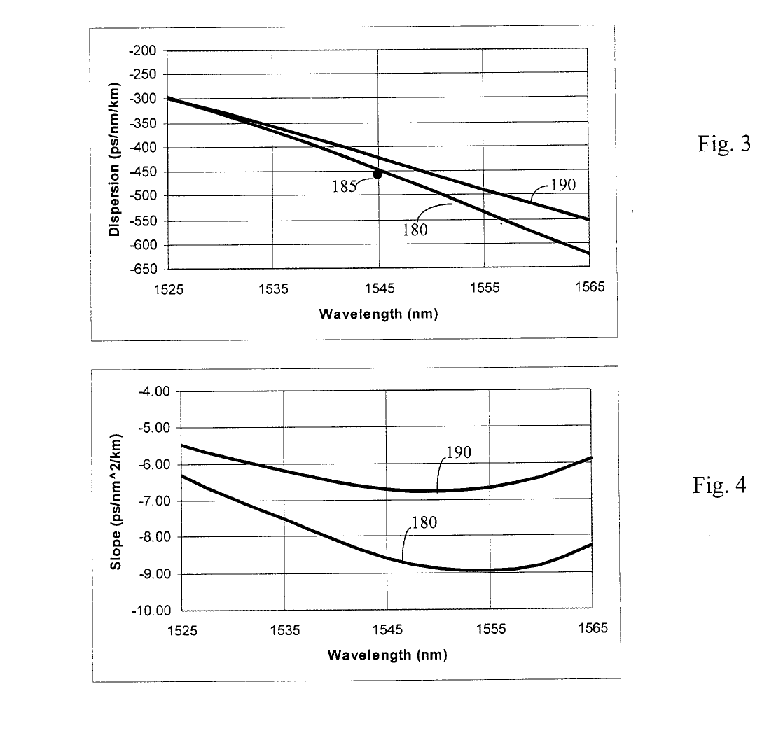

FIG. 3 illustrates a plot of the dispersion in the LP₀₂ mode for the few mode fiber profile 110 of FIG. 2, with the x-axis representing wavelength, and the y-axis representing dispersion in ps/nm/km. Curve 180 represents the calculated dispersion in the LP₀₂ mode for fiber profile 110 including the fourth core area 150, and curve 190 represents the calculated dispersion in the LP₀₂ mode for fiber profile 110 with comparison area 160, i.e. without fourth core area 150. Point 185 indicates the average dispersion of curve 180, approximately −450 ps/nm/km over the range of 1525-1565 nm. It is to be noted that curve 180 exhibits more negative dispersion than curve 190 over the majority of wavelength 1525 to 1565 nm.

FIG. 4 illustrates a plot of the local slope in the LP₀₂ mode for the few mode fiber profile 110 of FIG. 2 over the “C” waveband, with the x-axis representing wavelength, and the y-axis representing local slope in ps/nm²/km. Curve 180 represents the calculated local slope in the LP₀₂ mode for fiber profile 110 including the fourth core area 150, and curve 190 represents the calculated local slope in the LP₀₂ mode for fiber profile 110 with comparison area 160, i.e. without fourth core area 150. The fiber including fourth core area 150 represented by curve 180 exhibits increased negative local slope over the entire operative waveband as compared to curve 190. Local slope at 1525 nm is approximately −6.32 ps/nm²/km, local slope at 1550 nm is approximately −8.89 ps/nm²/km and local slope at 1565 nm is approximately −8.26 ps/nm²/km.

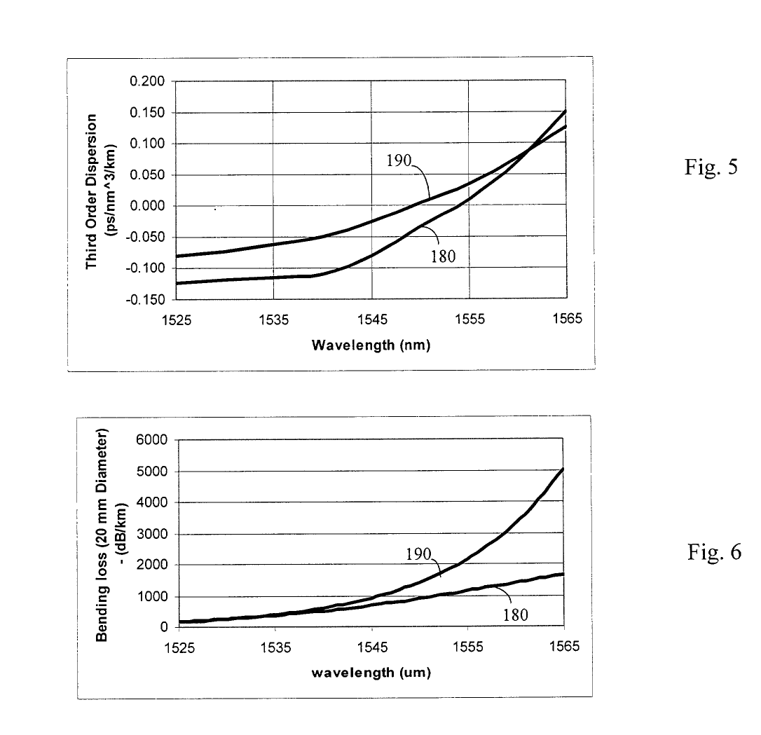

FIG. 5 illustrates a plot of the local third order dispersion in the LP₀₂ mode for the few mode fiber profile 110 of FIG. 2 over the “C” waveband, with the x-axis representing wavelength, and the y-axis representing local third order dispersion in ps/nm³/km. Curve 180 represents the calculated local slope in the LP₀₂ mode for fiber profile 110 including the fourth core area 150, and curve 190 represents the calculated local slope in the LP₀₂ mode for fiber profile 110 with comparison area 160, i.e. without fourth core area 150. The fiber including fourth core area 150, as represented by curve 180 exhibits only marginally increased local third order dispersion as compared with curve 190, being approximately −0.12 ps/nm³/km at 1525 nm, −0.035 ps/nm³/km at 1550 nm and 0.15 ps/nm³/km at 1565 nm.

FIG. 6 illustrates a plot of the calculated bending loss for a 50 mm bending diameter for the few mode fiber profile 110 of FIG. 2, with the x-axis representing wavelength, and the y-axis representing loss in db/km for the LP₀₂ mode. Curve 180 represents the calculated bending loss in the LP₀₂ mode for fiber profile 110 including the fourth core area 150, and curve 190 represents the calculated bending loss in the LP₀₂ mode for fiber profile 110 with comparison area 160, i.e. without fourth core area 150. Curve 180 exhibits greater resistance to bending loss than that of curve 190, with the increased resistance being more pronounced at longer wavelengths.

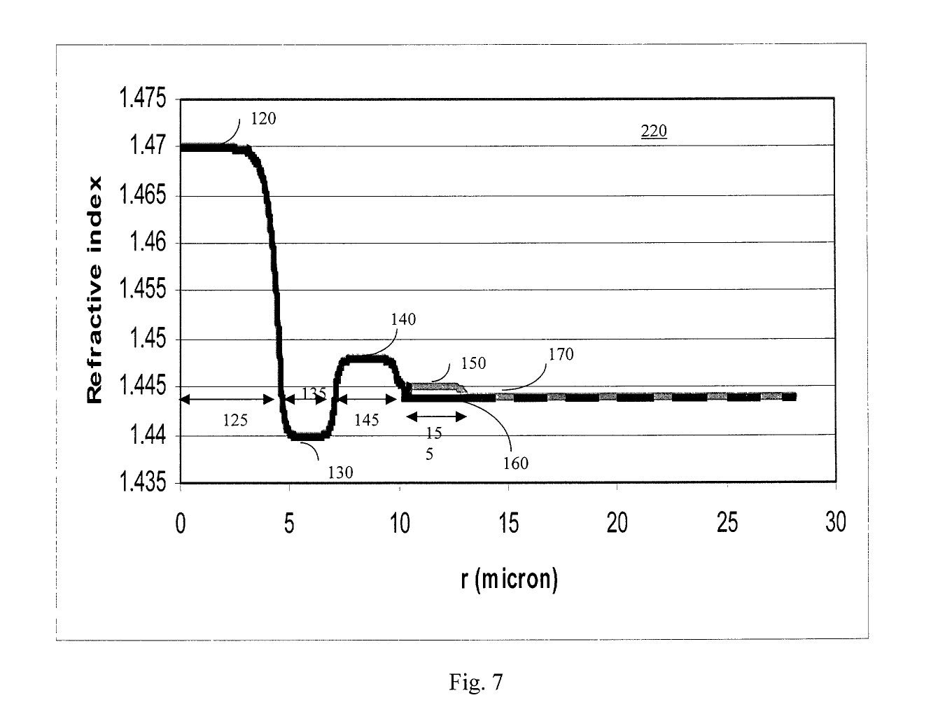

FIG. 7 illustrates a profile 220 of a few mode fiber designed to have negative dispersion, negative slope and improved bending loss in the “L” band of 1565 nm-1615 nm in accordance with a second embodiment of the subject invention. It is to be understood that the operative waveband may be less than or greater than 50 nm wide, and may not be centered on 1590 nm, although without exceeding the scope of the invention. The x-axis represents fiber radius and the y-axis represents the refractive index at a wavelength of 1550 nm. Fiber profile 220 comprises first core area 120 exhibiting radius 125, adjacent second core area 130 exhibiting width 135, adjacent third core area 140 exhibiting width 145, adjacent fourth core area 150 exhibiting width 155 and adjacent cladding area 170. Cladding area 160 adjacent to third core area 140 is shown for comparison. First core area 120 has a general shape wherein the refractive index varies over the radius 125 with a peak refractive index of 1.4700 corresponding to Δ₁ of 1.80%, and a radius of approximately 4.61 microns. Second core area 130 has a general shape exhibiting a depressed index of approximately 1.44 corresponding to Δ₂ of −0.28%, with a width 135 of approximately 2.46 microns. Third core area 140 exhibits a general shape with an increased refractive index of approximately 1.4480 corresponding to Δ₃ of 0.28%, which is significantly lower than first core area 120. Third core area 140 covers a width of approximately 3.19 microns. Fourth core area 150 exhibits an increased refractive index of approximately 1.4450 corresponding to Δ₄ of 0.07%, which while significantly lower than third core area 140, is still increased in relation to cladding area 170. Fourth core area 150 covers a width of approximately 2.88 microns. Cladding area 170 extends the balance of the radius of the fiber as is known to those skilled in the art. Total fiber radius is approximately 125 microns, however other fiber radii may be utilized without exceeding the scope of the invention.

In comparison, cladding area 160 is shown, which represents the fiber profile without the fourth cladding area 150. Thus without fourth cladding area 150, the refractive index declines to 1.444 at the end of third core area 140, and continues through cladding area 170 at the undoped refractive index of silica glass. Fourth area 150 is designed to improve the dispersion characteristics of profile 220 in the LP₀₂ mode, while not supporting any additional modes that would not have been supported in the profile without the additional fourth area. In a preferred embodiment, fourth core area 150 has a peak refractive index less than 1.446 corresponding to a maximum Δ₄ of 0.14%. In order to be effective, in a preferred embodiment fourth core area 150 covers a minimum width of at least 2 microns.

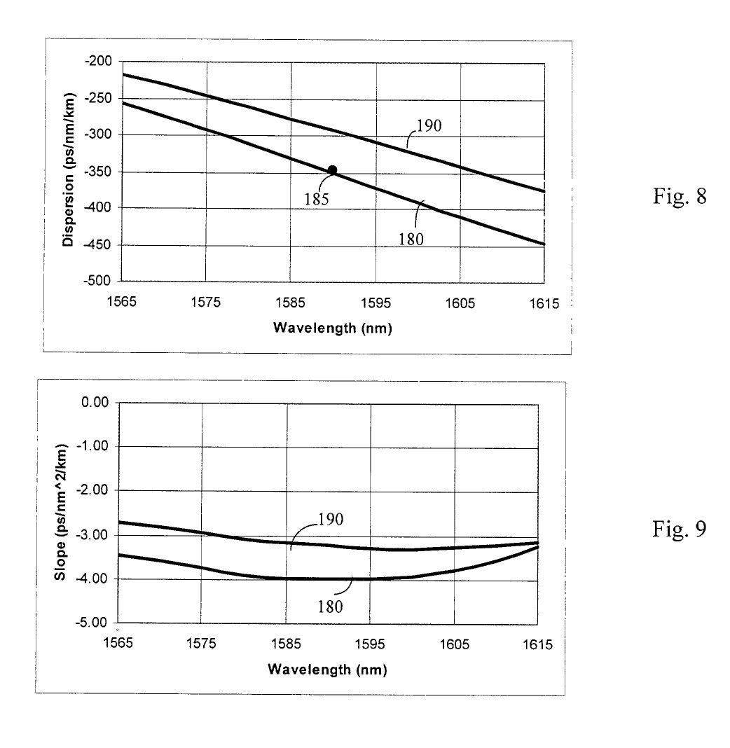

FIG. 8 illustrates a plot of the dispersion in the LP₀₂ mode for the few mode fiber profile 220 of FIG. 7, with the x-axis representing wavelength, and the y-axis representing dispersion in ps/nm/km. Curve 180 represents the calculated dispersion in the LP₀₂ mode for fiber profile 220 including the fourth core area 150, and curve 190 represents the calculated dispersion in the LP₀₂ mode for fiber profile 220 with comparison area 160, i.e. without fourth core area 150. Point 185 indicates the average dispersion of curve 180, approximately −350 ps/nm/km over the range of 1565-1615 nm. Curve 180 exhibits greater negative dispersion than curve 190 over the operating wavelength 1565 to 1615 nm.

FIG. 9 illustrates a plot of the local slope in the LP₀₂ mode for the few mode fiber profile 220 of FIG. 7 over the “L” waveband, with the x-axis representing wavelength, and the y-axis representing local slope in ps/nm²/km. Curve 180 represents the calculated local slope in the LP₀₂ mode for fiber profile 220 of FIG. 7 including the fourth core area 150, and curve 190 represents the calculated local slope in the LP₀₂ mode for fiber profile 220 with comparison area 160, i.e. without fourth core area 150. Curve 180 exhibits increase negative local slope as compared with curve 190, with local slope at 1565 nm being approximately −3.45 ps/nm²/km, local slope at 1590 nm being approximately −3.98 ps/nm²/km and local slope at 1615 nm being approximately −3.23 ps/nm²/km.

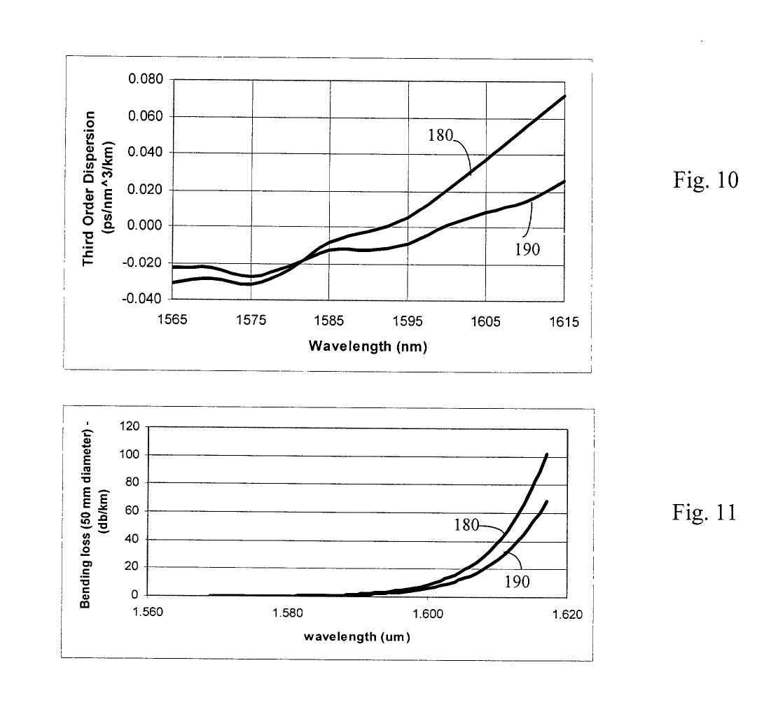

FIG. 10 illustrates a plot of the local third order dispersion in the LP₀₂ mode for the few mode fiber profile 220 of FIG. 7 over the “L” waveband, with the x-axis representing wavelength, and the y-axis representing local third order dispersion in ps/nm³/km. Curve 180 represents the calculated local third order dispersion in the LP₀₂ mode for fiber profile 110 including the fourth core area 150, and curve 190 represents the calculated local third order dispersion in the LP₀₂ mode for fiber profile 110 with comparison area 160, i.e. without fourth core area 150. Curve 180 exhibits very low local third order dispersion at shorter wavelengths, with values of approximately −0.03 ps/nm³/km at 1565 nm, 0.00 at 1590 nm and 0.07 ps/nm³/km at 1615 nm.

FIG. 11 illustrates a plot of the calculated bending loss for a 50 mm bending diameter for the few mode fiber profile 220 of FIG. 7, with the x-axis representing wavelength, and the y-axis representing loss in db/km for the LP₀₂ mode. Curve 180 represents the calculated bending loss in the LP₀₂ mode for fiber profile 220 including the fourth core area 150, and curve 190 represents the calculated bending loss in the LP₀₂ mode for fiber profile 220 with comparison area 160, i.e. without fourth core area 150. Curve 180 exhibits greater resistance to bending loss, which is more pronounced at longer wavelengths.

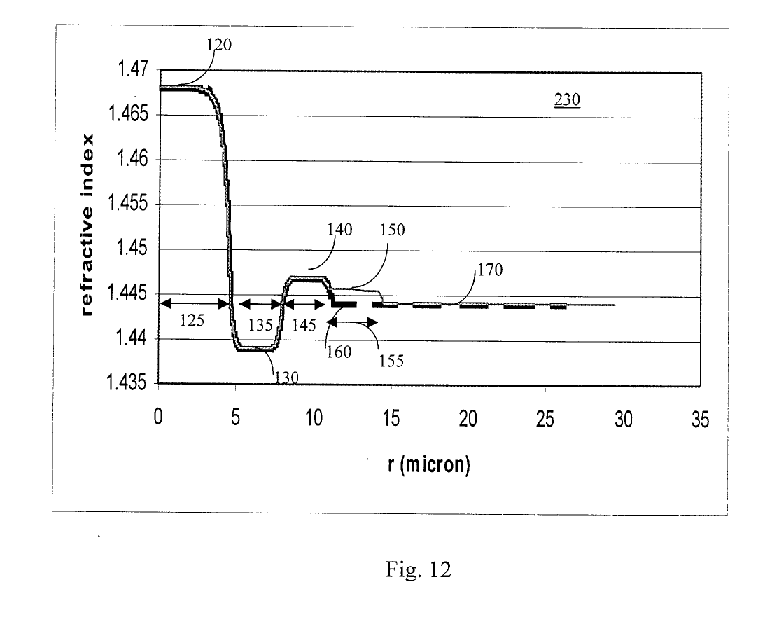

FIG. 12 illustrates a profile 230 of a few mode fiber designed to have negative dispersion, negative slope and improved bending loss in the “C” band of 1525 nm-1565 nm in accordance with a third embodiment of the subject invention. It is to be understood that the operative waveband may be less than or greater than 40 nm wide, and may not be centered on 1545 nm, although without exceeding the scope of the invention. The x-axis represents fiber radius and the y-axis represents the refractive index at a wavelength of 1550 nm. Fiber profile 230 comprises first core area 120 exhibiting radius 125, adjacent second core area 130 exhibiting width 135, adjacent third core area 140 exhibiting width 145, adjacent fourth core area 150 exhibiting width 155 and adjacent cladding area 170. Cladding area 160 adjacent to third core area 140 is shown for comparison. First core area 120 has a general shape wherein the refractive index varies over the radius 125 with a peak refractive index of 1.4680 corresponding to Δ₁ of 1.66%, and a radius of approximately 4.62 microns. Second core area 130 has a general shape exhibiting a depressed index of approximately 1.4390 corresponding to Δ₂ of −0.35%, with a width 135 of approximately 3.01 microns. Third core area 140 exhibits a general shape with an increased refractive index of approximately 1.4470 corresponding to Δ₃ of 0.21%, which is significantly lower than first core area 120. Third core area 140 covers a width of approximately 3.39 microns. Fourth core area 150 exhibits an increased refractive index of approximately 1.4456 corresponding to Δ₄ of 0.11%, which while significantly lower than third core area 140, is still increased in relation to cladding area 170. Fourth core area 150 covers a width of approximately 3.50 microns. Cladding area 170 extends the balance of the radius of the fiber as is known to those skilled in the art. Total fiber radius is approximately 125 microns, however other fiber radii may be utilized without exceeding the scope of the invention.

In comparison, cladding area 160 is shown, which represents the fiber profile without the fourth cladding area 150. Thus without fourth cladding area 150, the refractive index declines to 1.444 at the end of third core area 140, and continues through cladding area 170 at the undoped refractive index of silica glass. Fourth area 150 is designed to improve the dispersion characteristics of profile 230 in the LP₀₂ mode, while not supporting any additional modes that would not have been supported in the profile without the additional fourth area. In a preferred embodiment, fourth core area 150 has a peak refractive index less than 1.446 corresponding to a maximum Δ₄ of 0.14%. In order to be effective, in a preferred embodiment fourth core area 150 covers a minimum width of at least 2 microns.

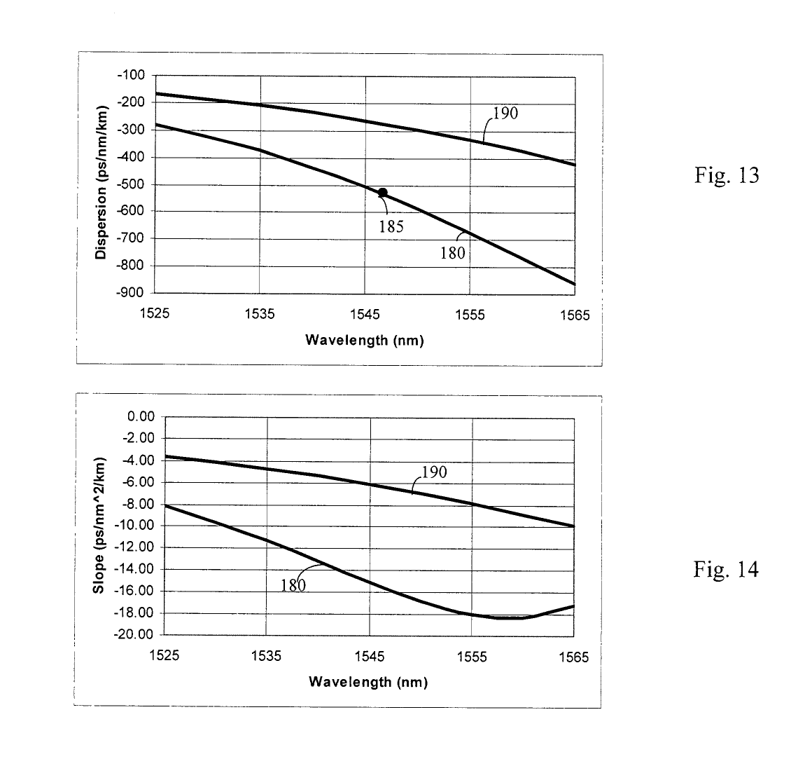

FIG. 13 illustrates a plot of the dispersion in the LP₀₂ mode for the few mode fiber profile 230 of FIG. 12, with the x-axis representing wavelength, and the y-axis representing dispersion in ps/nm/km. Curve 180 represents the calculated dispersion in the LP₀₂ mode for fiber profile 230 including the fourth core area 150, and curve 190 represents the calculated dispersion in the LP₀₂ mode for fiber profile 230 with comparison area 160, i.e. without fourth core area 150. Point 185 indicates the average dispersion of curve 180, approximately −530 ps/nm/km over the range of 1525-1565 nm. Curve 180 exhibits significantly greater negative dispersion than curve 190 over the operating wavelength 1525 to 1565 nm.

FIG. 14 illustrates a plot of the local slope in the LP₀₂ mode for the few mode fiber profile 230 of FIG. 12 over the “C” waveband, with the x-axis representing wavelength, and the y-axis representing local slope in ps/nm²/km. Curve 180 represents the calculated local slope in the LP₀₂ mode for fiber profile 230 of FIG. 10 including the fourth core area 150, and curve 190 represents the calculated local slope in the LP₀₂ mode for fiber profile 230 with comparison area 160, i.e. without fourth core area 150. Curve 180 exhibits significantly increased negative local slope as compared with curve 190, with local slope at 1525 nm being approximately −8.14 ps/nm²/km, local slope at 1550 nm being approximately −16.78 ps/nm²/km and local slope at 1565 nm being approximately −17.20 ps/nm²/km.

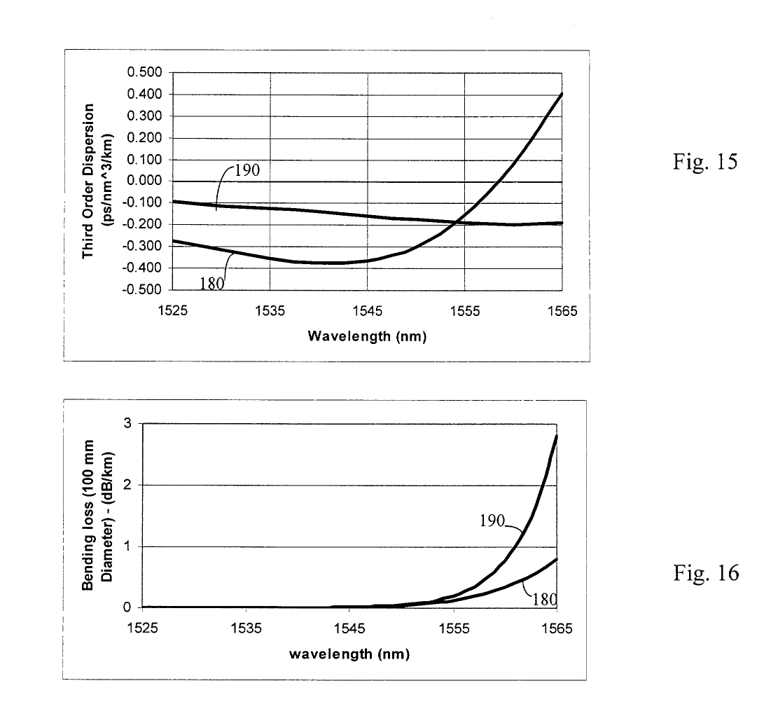

FIG. 15 illustrates a plot of the local third order dispersion in the LP₀₂ mode for the few mode fiber profile 230 of FIG. 12 over the “C” waveband, with the x-axis representing wavelength, and the y-axis representing local third order dispersion in ps/nm³/km. Curve 180 represents the calculated local third order dispersion in the LP₀₂ mode for fiber profile 230 including the fourth core area 150, and curve 190 represents the calculated local third order dispersion in the LP₀₂ mode for fiber profile 230 with comparison area 160, i.e. without fourth core area 150. Curve 180 exhibits local third order dispersion of approximately −0.27 ps/nm³/km at 1525 nm, −0.30 at 1550 nm and 0.40 ps/nm³/km at 1565 nm.

FIG. 16 illustrates a plot of the calculated bending loss for a 50 mm bending diameter for the few mode fiber profile 230 of FIG. 12, with the x-axis representing wavelength, and the y-axis representing loss in db/km for the LP₀₂ mode. Curve 180 represents the calculated bending loss in the LP₀₂ mode for fiber profile 230 including the fourth core area 150, and curve 190 represents the calculated bending loss in the LP₀₂ mode for fiber profile 230 with comparison area 160, i.e. without fourth core area 150. Curve 180 exhibits greater resistance to bending loss, which is more pronounced at longer wavelengths.

It is appreciated that certain features of the invention, which are, for clarity, described in the context of separate embodiments, may also be provided in combination in a single embodiment. Conversely, various features of the invention that are, for brevity, described in the context of a single embodiment, may also be provided separately or in any suitable subcombination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described herein above. Rather the scope of the present invention is defined by the appended claims and includes both combinations and subcombinations of the various features described hereinabove as well as variations and modifications thereof, which would occur to persons skilled in the art upon reading the foregoing description.

We claim:

1. A limited mode dispersion compensating optical fiber supporting at least one high order spatial mode comprising:
a first core area having a refractive index designated nc₁;
a second core area contactingly surrounding said first core area having a peak refractive index designated nc₂;
a third core area contactingly surrounding said second core area having a peak refractive index designated nc₃;
a fourth core area contactingly surrounding said third core area having a peak refractive index designated nc₄; and
a cladding area surrounding said third core area having a refractive index designated n_{clad};
wherein said peak refractive index nc₁ is greater than nc₂, nc₃, nc₄ and nc_{clad}, said peak refractive index nc₃ is greater than said nc₄ and said nc_{clad}, and said peak refractive index nc₄ is between said nc_{clad} and nc_{clad} plus 0.002 and
wherein said optical fiber exhibits average dispersion more negative than −250 ps/nm/km in said high order spatial mode over an operative wavelength range.

2. The limited mode dispersion compensating fiber of claim 1 wherein peak refractive index nc₂ is less than said nc_{clad}.

3. The limited mode dispersion compensating optical fiber of claim 1 wherein said optical fiber further exhibits negative local slope over said operative wavelength range.

4. The limited mode dispersion compensating optical fiber of claim 3 wherein said local slope is more negative than −3 ps/nm²/km over said operative wavelength range.

5. The limited mode dispersion compensating optical fiber of claim 1 wherein said optical fiber further exhibits local third order dispersion whose absolute value is less than 0.15 ps/nm³/km over said operative wavelength range.

6. The limited mode dispersion compensating optical fiber of claim 3 wherein said optical fiber further exhibits local third order dispersion whose absolute value is less than 0.15 ps/nm³/km over said operative wavelength range.

7. The limited mode dispersion compensating optical fiber of claim 2 wherein said optical fiber further exhibits negative local slope over said operative wavelength range.

8. The limited mode dispersion compensating optical fiber of claim 7 wherein said optical fiber exhibits local slope more negative than −3 ps/nm²/km over said operative wavelength range.

9. The limited mode dispersion compensating optical fiber of claim 2 wherein said optical fiber further exhibits local third order dispersion whose absolute value is less than 0.15 ps/nm³/km over said operative wavelength range.

10. The limited mode dispersion compensating optical fiber of claim 7 wherein said optical fiber further exhibits local third order dispersion whose absolute value is less than 0.15 ps/nm³/km over said operative wavelength range.

11. The limited mode dispersion compensating optical fiber of claim 1 wherein said high order spatial mode is the LP₀₂ mode.

12. The limited mode dispersion compensating optical fiber of claim 1 wherein said operative wavelength range comprises at least a portion of the wavelengths between 1525 nm and 1565 nm.

13. The limited mode dispersion compensating optical fiber of claim 1 wherein said operative wavelength range comprises at least a portion of the wavelengths between 1565 nm and 1615 nm.

14. The limited mode dispersion compensating optical fiber of claim 1 wherein said average dispersion is more negative than −400 ps/nm/km over said operative wavelength range.

15. The limited mode dispersion compensating optical fiber of claim 2 wherein said average dispersion is more negative than −400 ps/nm/km over said operative wavelength range.

16. An optical communication system comprising:
an optical transmission fiber exhibiting positive dispersion and positive dispersion slope;
a limited mode dispersion compensating optical fiber in optical serial communication with said optical transmission fiber, said limited mode dispersion compensating optical waveguide supporting the LP₀₂ mode; and
a mode transformer in optical communication with said limited mode dispersion compensating optical fiber;
wherein said limited mode dispersion compensating optical fiber comprises:
a first core area having a refractive index designated nc₁;
a second core area contactingly surrounding said first core area having a peak refractive index designated nc₂;
a third core area contactingly surrounding said second core area having a peak refractive index designated nc₃;
a fourth core area contactingly surrounding said third core area having a peak refractive index designated nc₄; and
a cladding area surrounding said third core area having a refractive index designated n_{clad};
wherein said peak refractive index nc₁ is greater than nc₂, nc₃, nc₄ and nc_{clad}, said peak refractive index nc₃ is greater than said nc₄ and said nc_{clad}, and said peak refractive index nc₄ is greater than said nc_{clad}.; and
wherein said optical fiber exhibits average dispersion more negative than −250 ps/nm/km in said high order spatial mode over an operative wavelength range.

17. The optical communication system of claim 16 wherein said limited mode dispersion compensating fiber exhibits negative local slope over said operative wavelength range.

18. The optical communication system of claim 16 wherein said limited mode dispersion compensating fiber exhibits local slope more negative than −3.0 ps/nm²/km over said operative wavelength range.

19. The optical communication system of claim 16 wherein said limited mode dispersion compensating fiber exhibits local third order dispersion whose absolute value is less than 0.15 ps/nm³/km over said operative wavelength range.

20. The optical communication system of claim 18 wherein said limited mode dispersion compensating fiber exhibits local third order dispersion whose absolute value is less than 0.15 ps/nm³/km over said operative wavelength range.
